(19) United States
(12) Patent Application Publication
(10) Pub. No.: US 2004/0219849 A1
(43) Pub. Date: Nov. 4, 2004

(54) Cover for an ironing board

(76) Inventors: James L. Glenn, St. Albans, MO (US); Richard Baldassarre, York, PA (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/427,092

(22) Filed: Apr. 30, 2003

(51) Int. Cl. B32B 3/00

(52) U.S. Cl. 442/181; 442/59; 156/76

(57) ABSTRACT

The present disclosure provides a fabric suitable for use as an ironing board cover having a fiberglass weave material and a backing material adhered to the fiberglass weave material. The backing material has a greater thickness than the fiberglass material. The adhered fiberglass weave and backing material is encapsulated within a silicone barrier dried over the adhered fiberglass weave and backing material such that fiberglass particles from the fiberglass weave are not easily dislodged from the fabric. A method of making the fabric is also disclosed.

### FIELD OF THE INVENTION

The present invention relates to ironing board covers.

### BACKGROUND OF THE INVENTION

In the past, many different materials have been used to form ironing board covers. For example, CALDURA is a trademark for a fabric available from Southern Mills, Inc. that is used for ironing board covers. The performance of CALDURA is acceptable for use as an ironing board cover, but the cost for CALDURA fabric is prohibitive for efficient use as an ironing board cover.

On the contrary, fiberglass-weave fabrics have an acceptable cost and exhibit excellent burn/scorch resistance, but the small fiberglass particles are too easily dislodged during use. These particles cause irritation to the skin and therefore make unmodified fiberglass weave fabrics an unacceptable ironing board cover material.

There are three known ways fabrics can be coated for both protection of the fabric and encapsulation of the material to prevent dislodging of the particles of the fabric: 1) running the fabric through a solution (dipping/submersing), 2) applying a solution by pouring it onto the surface of the fabric and smoothing it with a blade to remove excess, and 3) spraying the fabric with a solution as it passes by nozzle sprayers. However, these three methods have proven insufficient for encapsulating a fiberglass material because the solution will not adhere to the fiberglass material.

### SUMMARY OF THE INVENTION

The present invention provides a fabric suitable for use as an ironing board cover comprising a fiberglass weave material and a backing material adhered to the fiberglass weave material. The backing material has a greater thickness than the fiberglass material. The adhered fiberglass weave and backing material is saturated with a silicone barrier that is dried over the adhered fiberglass weave and backing material such that fiberglass particles from the fiberglass weave are not easily dislodged from the fabric.

A method of making the fabric is also disclosed comprising the steps of: 1) providing a fiberglass weave material, 2) adhering a backing material to the fiberglass weave material of a greater thickness than the fiberglass material, 3) using a printing process to supply a quantity of a water and silicone solution to the adhered backing material and fiberglass material in a quantity sufficient to saturate the adhered fiberglass and backing material, and 4) drying the saturated adhered fiberglass and backing material.

### DESCRIPTION OF THE PREFERRED EMBODIMENT

While the invention is susceptible of embodiment in many different forms, there is described in detail preferred embodiments of the invention. It is to be understood that the present disclosure is to be considered only as an example of the principles of the invention. This disclosure is not intended to limit the broad aspect of the invention to the illustrated embodiments. The scope of protection should only be limited by the claims.

The present invention comprises an ironing board cover material with improved burn/scorch characteristics over known ironing board covers. The ironing board covers of the present invention also present a more cost effective approach to making an ironing board cover. In the ironing board covers of the present invention, woven fiberglass material made from 100% virgin fiberglass is used a base sheet. The fiberglass material preferably has a thickness of from about 0.05 mm to about 0.40 mm, more preferably of from about 0.10 mm to about 0.30 mm, more preferably of from about 0.15 mm to about 0.20 mm, and most preferably of from about 0.16 to about 0.18 mm. Next, a fiber pad is woven made from 70% virgin polyester and 30% recycled polyester is laminated to the fiberglass material. The fiber pad has a thickness of from about 1 to about 6 mm, more preferably of from about 1 to about 5 mm, more preferably of from about 2 to about 4 mm and most preferably about 3 mm. The laminating process is accomplished with a laminating roller machine applying glue and heat to adhere the two fabrics. Next the bonded fabric is coated by using a printing/roller process that controls the amount of solution applied to the fabric.

The solution applied by the printing/roller process was preferably 40-99% silicone and 1-60% water, more preferably 50-90% silicone and 10-50% water, more preferably 60-80% silicone and 20-40% water, more preferably 65-75% silicone and 25-35% water, and most preferably 70% silicone and 30% water. The solution adhered best to the fiberglass/polyester sheet when releasing just enough solution to saturate the adhered fiberglass weave and backing material. After the solution is applied, the pad is rolled forward to an oven where the fabric is dried at between 180 and 260 degrees Celsius, more preferably 200 and 240 degrees Celsius, and most preferably 220 degrees Celsius for about one (1) minute per six (6) meters.

This process was successful in bonding the silicone coating to the woven fiberglass material, thus putting a shield between the fabric and the garment being ironed. Therefore, positive containment of the small fiberglass particles that had previous been easily dislodged was accomplished.

While the specific embodiments have been described, numerous modifications come to mind without significantly departing from the spirit of the invention, and the scope of protection should only limited by the scope of the accompanying claims.

I claim:

1. A method of making a fabric suitable for use as an ironing board cover comprising the steps of:
providing a fiberglass weave material;
adhering a backing material to the fiberglass weave material of a greater thickness than the fiberglass material;
using a printing process to supply a quantity of a water and silicone solution to the adhered backing material and fiberglass material in a quantity sufficient to saturate the adhered fiberglass and backing material; and
drying the saturated adhered fiberglass and backing material.

2. The method of claim 1 wherein the backing material comprises a polyester backing material.

3. The method of claim 1 wherein the fiberglass weave material has a thickness of from about 0.05 mm to about 0.40 mm.

4. The method of claim 1 wherein the fiberglass weave material has a thickness of from about 0.16 mm to about 0.18 mm.

5. The method of claim 1 wherein the backing material is made from polyester and has a thickness of from about 1 mm to about 6 mm.

6. The method of claim 1 wherein the backing material is made from polyester and has a thickness of about 3 mm.

7. The method of claim 1 wherein the silicone solution comprises about 40-99% silicone and about 1-60% water.

8. The method of claim 1 wherein the silicone solution comprises about 70% silicone and about 30% water.

9. The method of claim 1 wherein the step of drying the saturated adhered fiberglass and backing material comprises the step of drying the saturated adhered fiberglass and backing material in an oven at about 220 degrees Celsius at a rate of a about one minute per six meters of material.

10. A fabric suitable for use as an ironing board cover comprising:
a fiberglass weave material;
a backing material adhered to the fiberglass weave material having a greater thickness than the fiberglass material;
a silicone encapsulation barrier dried over the adhered fiberglass weave and backing material such that fiberglass particles from the fiberglass weave are not easily dislodged from the fabric.

11. The fabric of claim 10 wherein the backing material comprises a polyester backing material.

12. The fabric of claim 10 wherein the fiberglass weave material has a thickness of from about 0.05 mm to about 0.40 mm.

13. The fabric of claim 10 wherein the fiberglass weave material has a thickness of from about 0.16 mm to about 0.18 mm.

14. The fabric of claim 10 wherein the backing material is made from polyester and has a thickness of from about 1 mm to about 6 mm.

15. The fabric of claim 10 wherein the backing material is made from polyester and has a thickness of about 3 mm.

16. A method of making a fabric suitable for use as an ironing board cover comprising the steps of:
providing a fiberglass weave material having a thickness of from about 0.05 mm to about 0.40 mm;
adhering a polyester backing material to the fiberglass weave material of a thickness of from about 1 mm to about 6 mm;
using a printing process to supply a quantity of a water and silicone solution to the adhered backing material and fiberglass material in a quantity sufficient to saturate the adhered fiberglass and backing material wherein the solution comprises about 40-99% silicone and about 1-60% water; and
drying the saturated adhered fiberglass and backing material.

17. The method of claim 16 wherein the fiberglass weave material has a thickness of from about 0.16 mm to about 0.18 mm.

18. The method of claim 16 wherein the backing material is made from polyester and has a thickness of about 3 mm.

19. The method of claim 16 wherein the silicone solution comprises about 70% silicone and about 30% water.

20. The method of claim 16 wherein the step of drying the saturated adhered fiberglass and backing material comprises the step of drying the saturated adhered fiberglass and backing material in an oven at about 220 degrees Celsius at a rate of a about one minute per six meters of material.
